(19) United States
(12) Patent Application Publication
(10) Pub. No.: US 2020/0293454 A1
(43) Pub. Date: Sep. 17, 2020

(54) MEMORY SYSTEM

(71) Applicant: TOSHIBA MEMORY CORPORATION, Minato-ku (JP)

(72) Inventors: Tomonori YOKOYAMA, Kawasaki (JP); Mitsunori Tadokoro, Fujisawa (JP); Satoshi Kaburaki, Meguro (JP)

(73) Assignee: TOSHIBA MEMORY CORPORATION, Minato-ku (JP)

(21) Appl. No.: 16/560,444

(22) Filed: Sep. 4, 2019

(30) Foreign Application Priority Data
Mar. 11, 2019 (JP) 2019-043396

(51) Int. Cl. G06F 12/10; G06F 12/0864; G06F 3/06

(52) U.S. Cl. CPC G06F 12/10; G06F 12/0864; G06F 3/0679; G06F 2212/304; G06F 3/0604; G06F 2212/657; G06F 3/0659

(57) ABSTRACT

A memory system includes: a non-volatile first memory; a second memory which is a set-associative cache memory including a plurality of ways; and a memory controller The first memory stores a plurality of pieces of first information each of which associates a logical address indicating a location in a logical address space of the memory system with a physical address indicating a location in the first memory. The plurality of pieces of first information includes second information and third information. The second information associates a logical address with a physical address in a first unit. The third information associates a logical address with a physical address in a second unit different from the first unit. The memory controller caches the second information only in a first way. The memory controller caches the third information only in a second way different from the first way.

### CROSS-REFERENCE TO RELATED APPLICATIONS

This application is based upon and claims the benefit of priority from Japanese Patent Application No. 2019-043396, filed on Mar. 11, 2019; the entire contents of which are incorporated herein by reference.

### FIELD

Embodiments described herein relate generally to a memory system.

### BACKGROUND

A memory system including a non-volatile memory as storage memory is known. In one example, the non-volatile memory is a NAND flash memory.

The memory system stores a group of address translation information in the non-volatile memory. Each piece of the address translation information is information that associates a logical address indicating a location in a logical address space with a physical address indicating a location in the non-volatile memory.

When translating a certain logical address to a physical address, the memory system requires address translation information that associates the logical address with a physical address. However, an access speed with respect to the non-volatile memory is not so fast, and thus, the time required for an address translation process increases if the address translation information is acquired from the non-volatile memory. Therefore, the memory system is provided with a cache memory in which a part of the group of address translation information is stored as cache data such that it is possible to acquire the address translation information at high speed.

### BRIEF DESCRIPTION OF THE DRAWINGS

FIG. 1 is a schematic diagram illustrating an example of a configuration of a memory system according to an embodiment;

FIG. 2 is an exemplary and schematic view for illustrating a logical address space of the memory system according to the embodiment in which a plurality of namespaces are allocated;

FIG. 3 is an exemplary and schematic view for illustrating a logical address for each namespace used by a host with respect to the memory system according to the embodiment;

FIG. 4 is an exemplary and schematic view for illustrating a configuration of an address translation information group according to the embodiment;

FIG. 5 is an exemplary and schematic view for illustrating a configuration of a cache memory according to the embodiment;

FIG. 6 is an exemplary and schematic view for illustrating a bit string used for search of a cache memory among bit strings of internal logical addresses according to the embodiment;

FIG. 7 is a flowchart for illustrating an example of an operation of assigning a translation unit according to the embodiment;

FIG. 8 is a flowchart for illustrating an example of an operation in response to an access command according to the embodiment; and

FIG. 9 is a flowchart for illustrating en example of an address translation process according to the embodiment.

### DETAILED DESCRIPTION

According to the present embodiment, a memory system is connectable to a host. The memory system includes: a non-volatile first memory; a second memory which is a set-associative cache memory including a plurality of ways; and a memory controller. The first memory is configured to store a plurality of pieces of first information each of which associates a logical address indicating a location in a logical address space of the memory system with a physical address indicating a location in the first memory. The plurality of pieces of first information includes second information and third information. The second information is first information that associates a logical address with a physical address in a first unit. The third information is first information that associates a logical address with a physical address in a second unit different from the first unit. The memory controller is configured to cache the first information corresponding to the second information only in a first way among the plurality of ways. The memory controller is further configured to cache the first information corresponding to the third information only in a second way different from the first way among the plurality of ways.

Hereinafter, a memory system according to the embodiment will be described in detail with reference to the attached drawings. Incidentally, the present invention is not limited to the embodiment.

### Embodiment

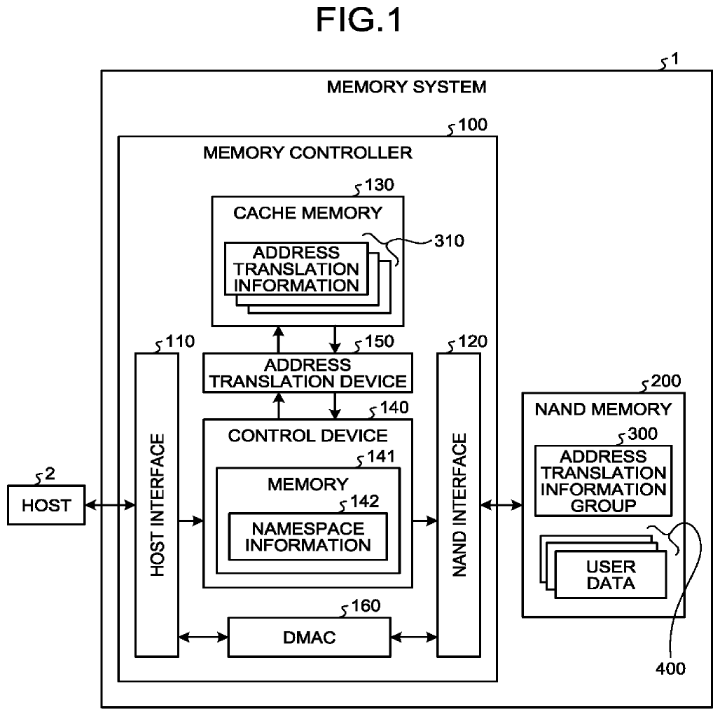

FIG. 1 is a schematic diagram illustrating an example of a configuration of the memory system according to the embodiment. A memory system 1 may be connected to a host The host 2 is, for example, a personal computer, a portable information terminal, or a server.

The memory system 1 conforms to the NVM Express (registered trademark) standard. According to the NVM Express (registered trademark) standard, one or more namespaces may be defined.

The memory system 1 creates a new namespace in response to a namespace create command from the host 2. When receiving the namespace create command, the memory system 1 allocates a part of a logical address space of the memory system 1 to a new namespace. A namespace ID is given to the namespace allocated to the logical address space.

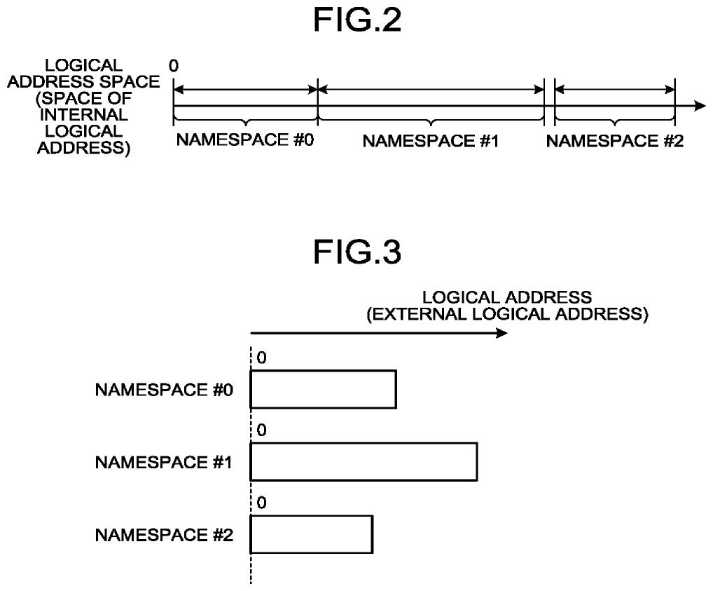

FIG. 2 is an exemplary and schematic view for illustrating the logical address space of the memory system 1 according to the embodiment in which a plurality of namespaces have been allocated. Here, a namespace whose namespace ID is X is referred to as a namespace #X. As illustrated in FIG. 2, the memory system 1 has a one-dimensional logical address space. Then, according to the example, the logical address space includes namespaces of namespaces #0 to #2. Ranges of logical addresses in the respective namespaces do not overlap each other.

FIG. 3 is an exemplary and schematic view for illustrating a logical address for each namespace used by the host 2. As illustrated in FIG. 3, consecutive logical addresses are allocated to the namespace #0, the namespace #1, and the namespace #2, respectively, with a leading logical address of the namespace as zero. The host 2 can designate a location of an access destination using a combination of a namespace ID (ID) and a logical address.

For example, when accessing the memory system 1, the host 2 transmits an access command (a read command or a write command) to the memory system 1. Each access command is accompanied by a namespace ID and a logical address indicating a location in a namespace. The memory system 1 translates the combination of the namespace ID and the logical address indicating the location in the namespace into a logical address in a logical address space of the memory system 1 on the basis of an allocation relationship.

Hereinafter, the logical address indicating the location in the namespace used by the host 2 is referred to as an external logical address. The logical address indicating the location in the logical address space of the memory system 1 is referred to as an internal logical address. The external logical address and the internal logical address will be collectively referred to as a logical address in some cases.

The host 2 transmits data to be written together with the write command. The write target data transmitted together with the write command is referred to as user data.

The description will be given with reference to FIG. 1 again.

The memory system 1 includes a memory controller 100 and a NAND flash memory (NAND memory) 200.

The NAND memory 200 is a non-volatile memory and is an example of a first memory. Any kind of non-volatile memory may be employed as the first memory.

The NAND memory 200 includes a memory cell array constituted by a plurality of blocks. Data stored in each block is erased at once. Each block includes a plurality of pages. Write of data to the memory cell array and read of data from the memory cell array are performed in a unit of a page.

The NAND memory 200 stores an address translation information group 300 and user data 400.

The address translation information group 300 is a group of address translation information. Each address translation information associates a representative value of a group of consecutive internal logical addresses having a certain width with a representative value of a group of consecutive physical addresses having the same width. As a result, each address translation information can linearly associate the consecutive internal logical addresses with the consecutive physical addresses. The above width is referred to as a translation unit.

The logical address is generally given in the granularity of a small area called a sector. Meanwhile, memory systems having an extremely large user capacity have been developed in recent years. Thus, when an internal logical address is to be associated with a physical address in a unit of a sector, a huge number of pieces of address translation information are required.

When the translation unit is larger than the sector, the required number of pieces of address translation information is smaller than the case when the translation unit is the sector. However, a group of consecutive internal logical addresses of a width corresponding to the translation unit is required to correspond to a group of consecutive physical addresses of the same width. Thus, for example, in the case of rewriting data of a size smaller than a size of the translation unit, it is necessary to write data of the size of the translation unit including the relevant data in the NAND memory. Accordingly, a write amplification factor (WAF) in the case of writing data smaller than the translation unit deteriorates as the translation unit increases. Further, the time required to rewrite data smaller than the translation unit increases as the translation unit. increases.

The translation unit also affects a cache hit rate. A part of the address translation information in the address translation information group 300 is stored as cache data in the cache memory 130 which can be accessed at a higher speed than the NAND memory 200. When desired address translation information is stored in the cache memory 130, the address translation information is acquired not from the NAND memory 200 but from the cache memory 130. Accordingly, the time required to acquire the address translation information is shortened.

When the translation unit is large, a range of logical addresses covered by address translation information stored in one cache line is large so that a high cache hit rate can be obtained. Conversely, when the translation unit is small, a range of logical addresses covered by address translation information stored in one cache line is small so that the cache hit rate is lowered.

In this manner, when the translation unit is large, the high cache hit rate can be achieved even with a small cache memory, but the access performance and WAF in the case of rewriting small-size data deteriorate. Conversely, when the translation unit is small, the deterioration of access performance and the deterioration of WAF in the case of rewriting the small-size data are suppressed, but it is disadvantageous in terms of the cache hit rate.

Here, when the memory system is used for an application of storing data of a large size, for example, a video file, there are a few cases where data of a smaller size than the translation unit is rewritten. Accordingly, when it is known that the memory system is used for such an application, by increasing the translation unit, it is possible to improve the cache hit rate while suppressing the deterioration of access performance and the deterioration of WAF.

In the embodiment, the memory system 1 is configured to be capable of making a translation unit different for each namespace and caching address translation information with the different translation units in the cache memory 130. As a result, for example, operations to be described below become possible. That is, the host 2 stores large-size data, such as a video file, in a namespace to which a large translation unit has been set so that a high cache hit rate can be obtained for the large-size data. Further, the host 2 stores small-size data in a namespace to which a small translation unit has been set so that it is possible to suppress the deterioration of access performance and WAF at the time of rewriting regarding the small-size data. In this manner, the host 2 can properly use a plurality of namespaces having different translation units depending on a size of data (the user data 400) to be written.

Incidentally, in the embodiment, it is assumed that a translation unit is designated by the host 2 when a new namespace is created. A command to designate the translation unit is referred to as a translation unit setting command. The translation unit setting command may be included in a namespace create command as an option of the namespace creates command, or may be a command that can be transmitted asynchronously with the namespace create command. A timing at which the translation unit is set is not limited only to the time when the new namespace is created.

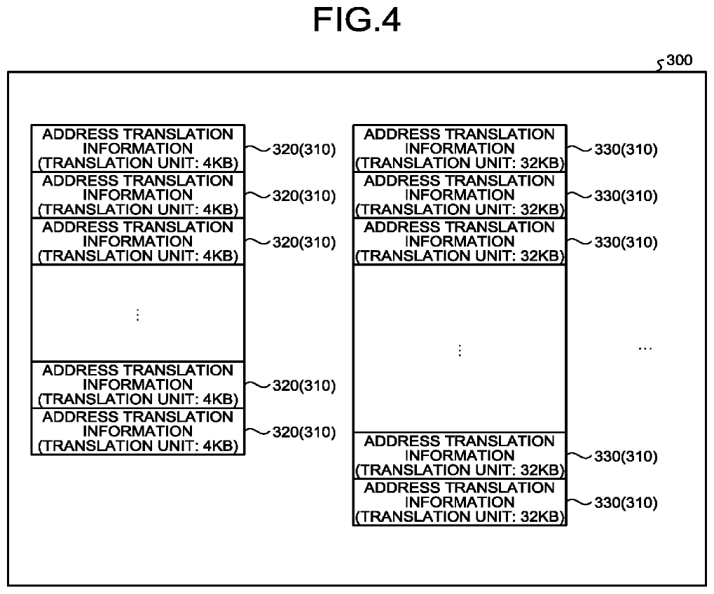

FIG. 4 is an exemplary and schematic view for illustrating a configuration of the address translation information group 300 according to the embodiment. As illustrated in FIG. 4, the address translation information group 306 includes one or more pieces of address translation information 320 in which a translation unit is a first unit and one or more pieces of address translation information 330 in which a translation unit is a second unit different from the first unit. The first unit is, for example, 4K bytes (=4096 bytes). Further, the second unit is, for example, 32K bytes (=32,768 bytes). Further, the address translation information 320 and the address translation information 330 will be collectively referred to as the address translation information 310 in some cases.

For example, when the first unit is designated as a translation unit at the time of creating the namespace #0, the memory system 1 generates the address translation information 320, which associates an internal logical address included in the namespace #0 with a physical address in the first unit, at the time of writing the user data 400 designated with the namespace #0 as a write destination into the NAND memory 200, for example. Then, the memory system 1 stores the generated address translation information 320 in the cache memory 130 or the NAND memory 200.

Further, for example, when the second unit is designated as a translation unit at the time of creating the namespace #1, the memory system 1 generates the address translation information 330, which associates an internal logical address included in the namespace #1 with a physical address in the second unit, at the time of writing the user data 400 designated with the namespace #1 as a write destination into the NAND memory 200, for example. Then, the memory system 1 stores the generated address translation information 330 in the cache memory 130 or the NAND memory 200.

Incidentally, the address translation information group 300 may include three or more pieces of address translation information 310 having mutually different translation units.

The description will be given with reference to FIG. 1 again.

The memory controller 100 includes a host interface 110, a NAND interface 120, a cache memory 130, a control device 140, an address translation device 150, and a direct memory access controller (DMAC) 160.

Some or all of the components included in the memory controller 100 may be configured using a hardware circuit such as a central processing unit (CPU), which operates based on a computer program. Further, some or all of the components included in the memory controller 100 may be configured using a hardware circuit, for example, a field-programmable gate array (FPGA), an application specific integrated circuit (ASIC), and the like. That is, the memory controller 100 can be configured using hardware, software, or a combination thereof. Incidentally, the memory controller 100 can be configured as a system-on-a-chip (SoC). The memory controller 100 may be configured using a plurality of chips

The cache memory 130 is a set-associative cache memory having a plurality of ways. The cache memory 130 is configured to be accessed faster than the NAND memory 200. The cache memory 130 may be a volatile memory or a non-volatile memory. The cache memory 130 is configured using, for example, a dynamic random access memory (DRAM) or a static random access memory (SRAM). The kind of the memory forming the cache memory 130 is not limited to the memory of the above-described kind.

The address translation information 310 is stored as cache data in the cache memory 130.

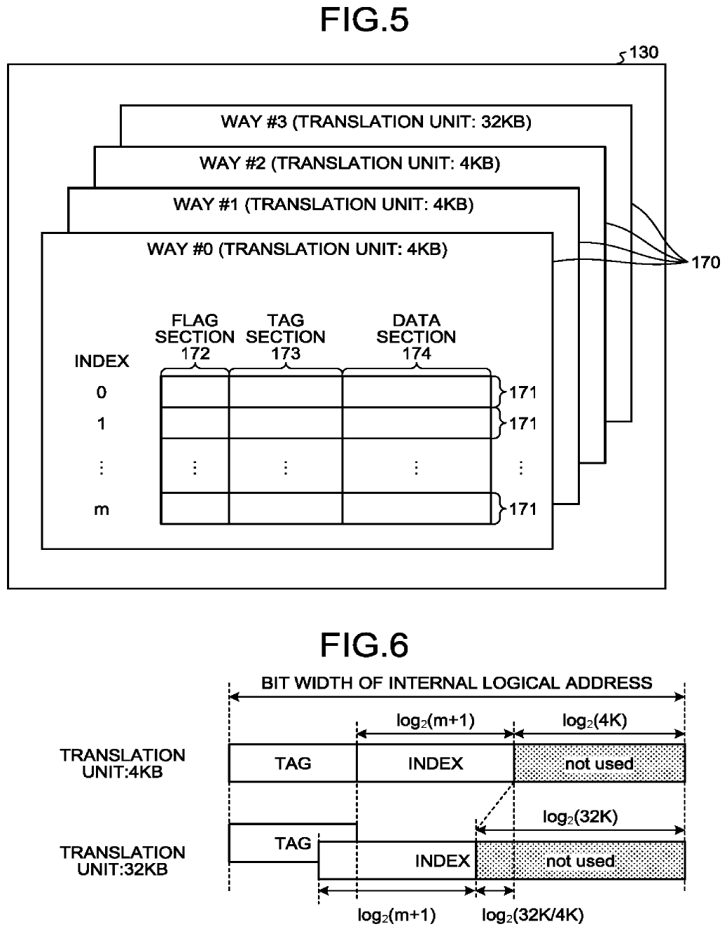

FIG. 5 is an exemplary and schematic view for illustrating a configuration of the cache memory 130 according to the embodiment. The cache memory 130 includes a plurality of ways 170. According to the example illustrated in FIG. 5, four ways 170 of a way #0, a way #1, a way #2, and a way #3 are provided.

Each of the four ways 170 includes (m+1) cache lines 171. Here, m is a positive integer. In each of the ways 170, a serial number called an index is given to each of the (m+1) cache lines 171. Zero is given as an index to the leading cache line 171, and any value in the range of 1 to m indicating a relative location from the leading cache line 171 is given as each index of each of the other cache lines 171.

Each of the cache lines 171 includes a flag section 172, a tag section 173, and a data section 174. Incidentally, the flag section 172 and the tag section 173 may be disposed outside the cache memory 130 as long as the flag section 172 and the tag section 173 are related to their corresponding data section 174.

The address translation information 310 is stored in the data section 174. The tag section 173 stores information called a tag. The flag section 172 stores one or more pieces of flag information to be used to control the cache line l71.

Examples of the lag information include a flag indicating whether information stored in the data section 174 is valid, a flag indicating whether information stored in the data section 174 is dirty, and the like. Incidentally, the examples of the flag information are not limited thereto.

One translation unit is assigned to each of the ways 170. In each of the ways 170, only address translation information 310 of the same translation unit as the assigned translation unit is stored.

For example, the translation unit of each of the way #0, the way #1, and the way #2 is 4K bytes according to the example in FIG. 5. Further, the translation unit of the way #3 is 32K bytes. That is, the address translation information 320 whose address translation unit is 4K bytes can be stored in any of the way #0, the way #1, and the way #2, but is not allowed to be stored in the way #3. Further, the address translation information 330 whose address translation unit is 32K bytes can be stored in the way #3, but is not allowed to be stored in the way #0, the way #1, and the way #2.

When searching the cache memory 130 configured as described above, a part of a bit string of the internal logical address is used as a tag, and another part of the bit string of the internal logical address is used as an index.

Here, each of the number of digits of the bit string of the tag and the number of digits of the bit string of the index is constant regardless of the translation unit. A bit string of the number of digits corresponding to the translation unit, on a lower side out of the bit string of the internal logical address, is unnecessary. Since the number of digits of the bit string regarded to be unnecessary differs depending on the translation unit, a part of the bit string of the internal logical address used as the index differs depending on the translation unit.

FIG. 6 is an exemplary and schematic view for illustrating each bit string used for search of the cache memory 130 among the bit strings of the internal logical addresses according to the embodiment.

For example, when the translation unit is 4K bytes, a bit string of 12 (=log₂(4 K)) digits on the lower side out of the bit string of the internal logical address is deleted. Then, a bit string of log₂(m+1) digits on the lower side out of the remaining bit string is used as an index. Then, the remaining bit string on the upper side is used as a tag.

Further, when the translation unit is 32K bytes, a bit string of 15 (=log₂(32K)) digits on the lower side out of the bit string of the internal logical address is deleted. Then, a bit string of log(m+1) digits on the lower side out of the remaining bit string is used as an index. Then, the upper hit string of the same number of digits as the case where the translation unit is 4K bytes is used as a tag.

In this manner, the tag and the index are acquired from the bit string of the internal logical address, and all the (m+1) cache lines 171 can be used regardless of the assigned translation unit.

The description will be given with reference to FIG. 1 again.

The host interface 110 is an interface device on the memory controller 100 side configured to execute transmission and reception of a command and the user data 400 between the host 2 and the memory controller 100. The NAND interface 120 is an interface device configured to execute access to the NAND memory 200.

The control device 140 is a device that controls the overall operation of the memory controller 100. In particular, the control device 140 receives a command from the host 2 via the host interface 110 and analyzes the received command. Then, the control device 140 instructs the NAND interface 120 to operate the NAND memory 200 in accordance with the analysis result. For example, when receiving an access command from the host 2, the control device 140 instructs the NAND interface 120 to execute access to the NAND memory 200 in response to the access command.

When the access command is a read command, the control device 140 converts an external logical address included in the read command into an internal logical address. Then, the control device 140 acquires a translation unit of the address translation information 310 for translation of the converted internal logical address into a physical address. Then, the control device 140 transmits a pair of the internal logical address and the acquired translation unit to the address translation device 150.

A method of acquiring the translation unit is freely designed. Here, the control device 140 includes a memory 141 as an example. The memory 141 is configured using, for example, a small memory such as a register or an SRAM. The memory 141 stores namespace information 142. The namespace information 142 indicates a correspondence between a namespace and a translation unit. In one example, the namespace information 142 is a list of pairs of namespace ID and a translation unit. Incidentally, a data structure of the namespace information 142 is not limited thereto. The control device 140 searches the namespace information 142 using the namespace ID included in the read command. Accordingly the control device 140 can acquire the translation unit of the address translation information 310 for translating the logical address included in the namespace of a read destination.

The address translation device 150 executes an address translation process to translate an internal logical address into a physical address. The address translation device 150 acquires a tag and an index from a bit string of an internal logical address received from the control device 140 in the address translation process. The index is acquired from a part of the bit string of the internal logical address that corresponds to the translation unit received in pair with the internal logical address.

The address translation device 150 searches the tag section 173 of the cache memory 130 using the acquired tag and index. Specifically, the address translation device 150 reads a tag from the tag section 173 of the cache line 171 indicated by the acquired index of each of the four ways 170. Then, the address translation device 150 compares the four tags obtained from the different ways 170 with the tag obtained from the internal logical address.

If any of the four tags obtained from the different ways 170 matches the tag obtained from the internal logical address, that is, if a result of the search is a cache hit, the address translation device 150 reads the address translation information 310 from the data section 174 of the cache line 171 from which the matched tag has been read. Then, the address translation device 150 translates the internal logical address into a physical address using the read address translation information 310.

If none of the four tags obtained from the different ways 170 matches the tag acquired from the internal logical address, that is, if the result of the search is a cache miss, the address translation device 150 executes refill of the address translation information 310 that associates the internal logical address with a physical address. Then, the address translation device 150 translates the internal logical address into the physical address using the address translation information 310 acquired by the refill.

Incidentally, the refill is a process of reading the address translation information 310 to associate an internal logical address with a physical address from a group of address translation information stored in the NAND memory 200, and storing the read address translation information 310 in any of the ways 170.

At the time of refill, the address translation device 150 selects the way 170 as a storage destination of the address translation information 310 from among one or more ways to which the same translation unit as the translation unit received in the pair with the internal logical address has been assigned. As a result, each of the ways 170 can store only the address translation information 310 of the same translation unit as the assigned translation unit.

Incidentally, when there are a plurality of the ways 170 to which the same translation unit as the translation unit received in the pair with the internal logical address has been assigned, the way 170 as a refill destination is determined using any method. The way 170 as the storage destination of the address translation information 310 can be determined using, for example, a method such as least recently used (IRU) and round robin.

Incidentally, the cache line 171 as the refill destination is the cache line 171 indicated by an index acquired from a portion corresponding to the translation unit in the bit string of the internal logical address.

Incidentally, when the cache line 171 as the refill destination is dirty, the address translation device 150 executes write hack before the refill in order to maintain cache consistency. The write back is a process of storing the content that has been stored in the cache line 171 into the NAND memory 200. The write back may be executed at any timing as long as it is executed prior to the refill. In the present specification, a detailed description of the write back will be omitted.

The address translation device 150 transmits the physical address obtained by the address translation process to the control device 140. The control device 140 causes the NAND interface 120 to execute a process of reading the user data 400 from a location indicated by the physical address received from the address translation device 150.

The DMAC 160 is a device that executes transfer of the user data 400 between the host. interface 110 and the NAND interface 120. The DMAC 160 executes transfer of the user data 400 using a method of direct memory access (DMA).

Subsequently, an operation of the memory system 1 of the embodiment will be described.

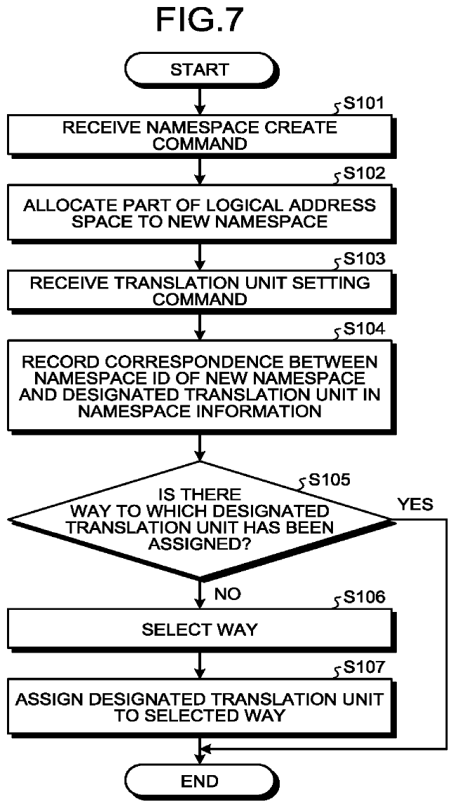

FIG. 7 is a flowchart for illustrating an example of an operation of assigning a translation unit according to the embodiment.

First, the control device 140 receives a namespace create command from the host 2 (S101). Then, the control device 140 allocates a part of an logical address space to a new namespace (S102). The control device 140 allocates the part of the logical address space, which has not been allocated to any namespace, to the new namespace.

Subsequently, the control device 140 receives a translation unit setting command from the host 2 (S103). Then, the control device 140 records a correspondence between a namespace ID of the namespace created by the process of S102 and a translation unit designated from the host 2 using the translation unit setting command in the namespace information 142 (S104).

Subsequently, the control device 140 determines whether the way 170 to which the designated translation unit has been assigned is present 105).

When the way 170 to which the designated translation unit has been assigned is not present(3105:

No), the control device 140 selects one way 170 from among all the ways 170 (S106), and assigns the designated translation unit to the selected way 170 (S107).

In S106, the control device 140 can select the way 170 using any method. For example, when a plurality of the ways 170 to which the same translation unit has been assigned are present, the control device 140 can select one of the plurality of ways 170. In another example, when a way 170 to which any translation unit has not been assigned is present, the control device 140 can select the way 170. In still another example, a way 170 having the lowest cache hit rate can be selected from among all the ways 170 or a plurality of the ways 170 to which the same translation unit has been assigned.

In S107, the control device 140 appropriately executes write back before changing the assignment of the translation unit to the selected way 170. The control device 140 invalidates all the cache lines 171 of the selected way 170 after execution of the write back.

When there is a way to which the designated translation unit has been assigned (S105: Yes), or after S107, the operation of assigning the translation unit is completed.

Incidentally, the timing of the assignment of the translation unit illustrated with reference to FIG. 7 is an example. The assignment of the translation unit can be executed at any timing.

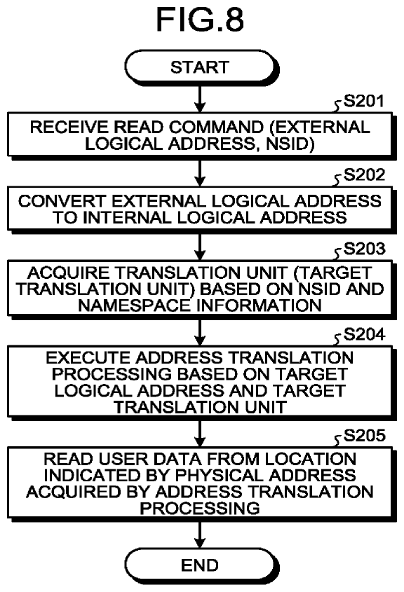

FIG. 8 is a flowchart for illustrating an example of an operation in response to an access command according to the embodiment. Here, the description will be given assuming that the access command is a read command as an example.

When receiving the read command from the host (S201), the control device 140 converts an external logical address included in the read command into an internal logical address (S202). The internal logical address acquired in S202 is referred to as a target logical address.

Subsequently, the control device 140 acquires a translation unit based on a namespace ID included in the read command and the namespace information 142 (S203). The translation unit acquired in S203 is referred to as a target translation unit.

The control device 140 transmits a pair of the target logical address and the target translation unit to the address translation device 150. The address translation device 150 executes an address translation process based on the target logical address and the target. translation unit (S204). A specific operation of the address translation process will be described later.

The address translation device 150 transmits a physical address corresponding to the target logical address acquired by the address translation process to the control device 140. The control device 140 executes a read process with respect to a location indicated by the physical address acquired by the address translation process 20

For example, in S205, the control device 140 instructs the NAND interface 120 to execute read with respect to the location indicated by the physical address acquired by the address translation process. The NAND interface 120 transmits, to the NAND memory 200, a read command to read the user data 400 from the location indicated by the physical address. The NAND memory 200 reads the user data 400 from the location indicated by the physical address, and outputs the user data 400 to the NAND interface 120. The DMAC 160 transmits the user data 400 received by the NAND interface 120 to the host 2 via the host interface 110.

With the process in S205, the operation in response to the read command is completed.

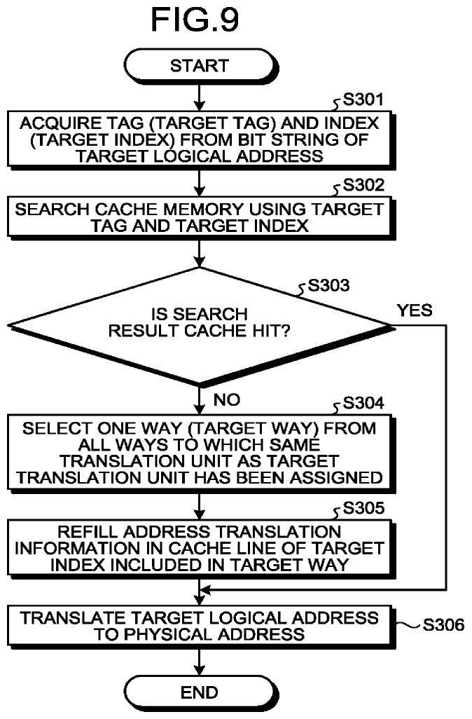

FIG. 9 is a flowchart for illustrating an example of the address translation process according to the embodiment, which is executed in S204.

First, the address translation device 150 acquires a tag and an index from a hit string of a target logical address (S301). The index is obtained from portion of the bit string of the target logical address that corresponds to a target translation unit.

Subsequently, the address translation device 150 searches the cache memory 130 using the target tag and the target index (S302). That is, the address translation device 150 reads tags from the tag sections 173 of the cache lines 171 indicated by the target index, of all the ways 170. Then, the address translation device 150 compares the plurality of tags obtained from the different ways 170 with the target tag.

If a search result is a cache miss (S303: No), that is, if all the tags obtained from the different ways 170 are different from the target tag, the address translation device 150 selects one way 170 (target way 170) from among all the ways to which the same translation unit as the target translation unit has been assigned (S304). Then, the address translation device 150 refills the address translation information 310 in the cache line 171 indicated by the target index among the (m+1) cache lines 171 of the target way 170 (S305).

In S305, the address translation device 150 acquires the address translation information 310 that associates the target logical address with a physical address from the NAND memory 200 via the control device 140 and the NAND interface 120, and stores the acquired address translation information 310 in the data section 174 of the cache line 171 indicated by the target index of the target way 170. Further, the address translation device 150 updates, with the tag acquired in 5301, the content of the tag section 173 of the cache line 171 indicated by the target index of the target way 170.

Incidentally, the address translation device 150 executes the write back if necessary before S305 as described above. During the write back, the address translation device 150 writes the address translation information 310, which has been stored in the data section 174 of the cache line 171 indicated by the target index of the target way 170, to the NAND memory 200 via the control device 140 and the NAND interface 120.

Subsequently to S305, the address translation device 150 translates the target logical address into the physical address using the refilled address translation information 310 (S306). The address translation process is completed by S306.

If the search result is a cache hit (S303: Yes), that is, if one of the plurality of tags read from the different ways 170 matches the target tag, the control shifts to S306. In S306, the address translation information 310 translates the target logical address into the physical address using the address translation information 310 stored in the data section 174 of the cache line 171 from which the matched tag has been read. Then, the address translation process ends

The memory system 1 configured to be capable of making the translation unit different for each namespace has been described as above. The translation unit may be configured to be determined in a different unit from a namespace. That is, a technique of the embodiment is also applicable to a memory system that does not conform to the NVM Express (registered trademark) standard.

For example, the memory system 1 may be configured to be capable of making a translation unit different for each stream. Further, the memory system 1 may be configured to be capable of making a translation unit different for each a logical unit number (LUN) or for each partition.

Further, the above description has been given assuming that the search of the cache memory 130 is implemented as a part of the address translation process. An execution timing of the search of the cache memory 130 is not limited to the address translation process.

Further, the above description has been given assuming that the address translation process is executed at the time of processing the read command. An execution timing of the address translation process is not limited to the processing of the read command.

Further, the above description has been given assuming that the single address translation information 310 is stored in the data section 174 of each cache line. The data section 174 of each cache line may store a plurality of pieces of the address translation information 310 relating to consecutive logical addresses. That is, the size of a cache line may be a size corresponding to the plurality of pieces of address translation information 310, and refill may be executed for each of the plurality of pieces of address translation information 310.

Further, it is assumed that the internal logical address is counted in the unit of 1 byte in the above description. The internal logical address may be counted in a unit of multiple bytes.

Incidentally, when a plurality of pieces address translation information 310 are cached in the data section 174 of each cache line or when the internal logical address is counted in a unit of multiple bytes, a width of a lower bit string to be deleted, illustrated in FIG. 6, may change.

For example, a width Wnotused of the lower bit string to be deleted is obtained by the following Formula (1).

Wnotused=log₂(N*U/C) (1)

In Formula (1), N is the number of pieces of address translation information 310 stored in the data section 174 of each cache line. U is a translation unit. C is a count unit of the internal logical address.

Incidentally, a configuration in which a different cache memory is prepared for each translation unit is conceivable as a technique to be compared with the embodiment. According to such a configuration according the technique to be compared with the embodiment, a mechanism to control cache for each cache memory is required, and thus, a circuit scale of the address translation device 150 increases depending on the number of cache memories. Since it is possible to make the translation unit different for each of the ways 170 in the embodiment, it is possible to reduce a circuit scale of a mechanism that controls the cache memory 130 as compared to the configuration according to the technique to be compared with the embodiment.

As described above, according to the embodiment, the address translation information group 300 includes the address translation information 320 that associates the logical address (internal logical address) with the physical address in the first unit (for example, 4 K bytes), and the address translation information 330 that associates the logical address (internal logical address) with the physical address in the second unit (for example, 32 K bytes) different from the first unit. The cache memory 130 is the set-associative cache memory including the plurality of ways 170. The memory controller 100 stores the address translation information 310, which corresponds to the address translation information 320 that associates a logical address (internal logical address) with a physical address in the first unit, only in a certain way 170 (for example, the way #0). Further, the memory controller 100 stores the address translation information 310, which corresponds to the address translation information 330 that associates a logical address (internal logical address) with a physical address in the second unit, only in another way 170 (for example, the way #3).

According to the above configuration, the memory system 1 can handle the plurality of pieces of address translation information 310 having different translation units, and acquire the address translation information 310 of each translation unit at high speed using the cache memory 130. As a result, the operation to switch the translation unit in accordance with a size of the user data 400 becomes possible. That is, the memory system 1 with high convenience can be obtained.

Further, the memory controller 100 can allocate a plurality of namespaces, which do not overlap each other, in the logical address space, and make the translation unit different for each namespace. That is, for example, the internal logical address belonging to one namespace is associated with a physical address in the first unit by the address translation information 320, and an internal logical address belonging to another namespace is associated with a physical address in the second unit by the address translation information 330.

With the above configuration, the host 2 can perform the operation to switch the namespace in accordance with the size of the user data 100 to be written to the memory system 1.

Further, when receiving a read command from the host 2, the memory controller 100 acquires the translation unit of the target logical address indicating the read destination, and acquires the index from the portion corresponding to the acquired translation unit in the bit string of the target logical address. Then, the memory controller 100 searches all the ways 170 using the acquired index.

According to the above configuration, it is possible to search the plurality of ways 170 with the different translation units of the stored address translation information 310 using the index having the same value.

Further, the memory controller 100 assigns the translation unit to each of the plurality of ways 170. The memory controller 100 stores only the address translation information 310 that associates an internal logical address with a physical address in the assigned translation unit in each of the plurality of ways 170. Further, if the result of the search is a cache miss, the way 170 as a refill destination is selected from among the one or more ways 170 to which the same translation unit as the translation unit of the target logical address indicating the read destination has been assigned.

According to the above configuration, it becomes possible to make the way 170 as the storage destination of the address translation information 310 different for each translation unit.

Incidentally, the memory controller 100 records the correspondence between the namespace and the translation unit in the namespace information 142 and acquires the translation unit of the target logical address based on the namespace information 142.

More specifically, the access command includes the namespace ID. The memory controller 100 acquires the translation unit of the target logical address based on the namespace ID and the namespace information 142.

Further, the memory controller 100 receives a translation unit setting command to designate the translation unit from the host 2. The memory controller 100 associates the translation unit designated by the translation unit setting command with one namespace.

According to the above configuration, the memory system 1 can set the translation unit to associate a logical address with a physical address indicating the location in the NAND memory 200, for each namespace.

While certain embodiments ave been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system connectable to a host, the memory system comprising:
a first memory that is non-volatile, the first memory being configured to store a plurality of pieces of first information each of which associates a logical address indicating a location in a logical address space of the memory system with a physical address indicating a location in the first memory, the plurality of pieces of first information including second information and third information, the second information being first information that associates a logical address with a physical address in a first unit, the third information being first information that associates a logical address with a physical address in a second unit different from the first unit;
a second memory that is a set-associative cache memory including a plurality of ways; and
a memory controller configured to cache the first information corresponding to the second information only in a first way among the plurality of ways and cache the first information corresponding to the third information only in a second way different from the first way among the plurality of ways.

2. The memory system according to claim 1, wherein
the memory controller is further configured to allocate a first space and a second space that does not overlap the first space, in the logical address space, wherein
one piece of the plurality pieces of first information that associates a logical address included in the first space with a physical address corresponds to the second information, and
one piece of the plurality pieces of first information that associates a logical address included in the second space with a physical address corresponds to the third information.

3. The memory system according to claim 2, wherein
the memory controller is further configured to:
when receiving from the host a first command requesting read, acquire a third unit in which the first information associates a target logical address with a physical address, the target logical address being a logical address that indicates a read destination;
in a case where the third unit corresponds to the first unit, acquire a first index from a first portion of a bit string of the target logical address, the first portion corresponding to the first unit, and determine a cache hit by searching each of the plurality of ways using the first index; and
in a case where the third unit corresponds to the second unit, acquire a second index from a second portion of a bit string of the target logical address, the second portion corresponding to the second unit and being different from the first portion, and determine a cache hit by searching each of the plurality of ways using the second index.

4. The memory system according to claim 3, wherein
the memory controller is further configured to:
assign a plurality of translation units including the first unit and the second unit to the plurality of ways;
cache the first information that associates a logical address with a physical address in the first unit only in a way to which the first unit is assigned; and
in a case where a result of the determination using the target logical address is not a cache hit, select a way of a refill destination from among one or more ways to which the first unit has been assigned.

5. The memory system according to claim 3, further comprising
a third memory,
wherein the memory controller is further configured to:
allocate a plurality of third spaces including the first space and the second space in the logical address space, the third spaces not overlapping each other;
store fourth information in the third memory, the fourth information recording a correspondence between each of the plurality of third spaces and a translation unit; and
acquire the third unit on the basis of the fourth information.

6. The memory system according to claim 5, wherein
each of the plurality of third spaces is a namespace,
the first command includes a namespace ID, and
the memory controller is configured to acquire the third unit on the basis of the fourth information and the namespace ID included in the first command.

7. The memory system according to claim 5, wherein
the memory controller is further configured to:
receive a second command that designates a fourth unit from the host; and
associate the designated fourth unit with one of the plurality of third spaces, the fourth unit being a unit for associating a logical address in the one of the plurality of third spaces with a physical address.

8. A memory system comprising:
a non-volatile memory; and
a controller configured to set different translation units for different namespaces, each of the translation unit being a unit for associating a logical address with a physical address indicating a location in the non-volatile memory.

9. A method for controlling a memory system which includes a first memory and a second memory, the first memory being non-volatile, the second memory being a set-associative cache memory including a plurality of ways, the method comprising:
storing, in the first memory, a plurality of pieces of first information each of which associates a logical address indicating a location in a logical address space of the memory system with a physical address indicating a location in the first memory, the plurality of pieces of first information including second information and third information, the second information being first information that associates a logical address with a physical address in a first unit, the third information being first information that associates a logical address with a physical address in a second unit different from the first unit;
caching, only in a first way among the plurality of ways, the first information corresponding to the second information; and
caching, only in a second way different from the first way among the plurality of ways, the first information corresponding to the third information.

10. The method according to claim 9 further comprising allocating a first space and a second space that does not overlap the first space, in the logical address space, wherein
one piece of the plurality pieces of first information that associates a logical address included in the first space with a physical address corresponds to the second information, and
one piece of the plurality pieces of first information that associates a logical address included in the second space with a physical address corresponds to the third information.

11. The method according to claim 10 further comprising:
when receiving from the host a first command requesting read, acquiring a third unit in which the first information associates a target logical address with a physical address, the target logical address being a logical address that indicates a read destination;
in a case where the third unit corresponds to the first unit, acquiring a first index from a first portion of a bit string of the target logical address, the first portion corresponding to the first unit, and determining a cache hit by searching each of the plurality of ways using the first index; and
in a case where the third unit corresponds to the second unit, acquiring a second index from a second portion of a bit string of the target logical address, the second portion corresponding to the second unit and being different from the first portion, and determining a cache hit by searching each of the plurality of ways using the second index.

12. The method according to claim 11 further comprising:
assigning a plurality of translation units including the first unit and the second unit to the plurality of ways;
caching the first information that associates a logical address with a physical address in the first unit only in a way to which the first unit is assigned; and
in a case where a result of the determination using the target logical address is not a cache hit, selecting a way of a refill destination from among one or more ways to which the first unit has been assigned.

13. The method according to claim 11, wherein
the memory system further includes a third memory,
the method further comprises:
allocating a plurality of third spaces including the first space and the second space in the logical address space, the third spaces not overlapping each other;
storing fourth information in the third memory, the fourth information recording a correspondence between each of the plurality of third spaces and a translation unit; and
acquiring the third unit on the basis of the fourth information.

14. The method according to claim 13, wherein
each of the plurality of third spaces is a namespace,
the first command includes a namespace ID, and
the method further comprises acquiring the third unit on the basis of the fourth information and the namespace ID included in the first command.

15. The method according to claim 13 further comprising:
receiving a second command that designates a fourth unit from the host; and
associating the designated fourth unit with one of the plurality of third spaces, the fourth unit being a unit for associating a logical address in the one of the plurality of third spaces with a physical address.
